(19) United States
(12) Patent Application Publication
(10) Pub. No.: US 2014/0144389 A1
(43) Pub. Date: May 29, 2014

(54) HUMAN SENSING PET DETERRENT SYSTEM FOR PROTECTING AN INDOOR AREA

(71) Applicant: Charles Elliot Richards, Simi Valley, CA (US)

(72) Inventor: Charles Elliot Richards, Simi Valley, CA (US)

(21) Appl. No.: 13/684,642

(22) Filed: Nov. 26, 2012

(51) Int. Cl. A01K 29/00

(52) U.S. Cl. CPC A01K 29/00
USPC 119/712

(57) ABSTRACT

A human sensing pet deterrent system for protecting a specific indoor area is disclosed. The human sensing pet deterrent system includes an ultrasonic detection system that determines whether a human or a pet is entering the protected area, a motorized fluid sprayer system in the proximity of the protected area, and a microcontroller which controls and provides communication between the systems. The fluid sprayer system delivers a spray or mist stimulus for a preset duration which discourages a pet from entering the protected area. If the ultrasonic detection system detects a human, the fluid spray system is deactivated for a preset duration, thereby enabling the human to enter the protected area.

### BACKGROUND OF THE INVENTION

1. Field of Invention

This invention relates to the field of systems for deterring a pet or pets from entering specific areas in a home. More specifically, the present invention relates to a pet deterrent system which discerns between a human entering a protected area and a pet entering a protected area and delivers a water spray stimulus only if at least one of the ultrasonic distance sensors detects a pet in the protected area. The system is deactivated for a preset period of time if a human is detected by the human detection system.

2. Description of the Related Art

Pet owners often have areas in their homes that are off-limits to pets. While some pet owners try to discipline their pets by training them not to enter specific areas or to not scratch or claw certain items, this method may prove costly and ineffective. Erecting a pet fence or pet barrier to prevent pets from entering a room or breaching an off-limits area may also prove ineffective. For example, the pet may be capable of jumping or climbing over such a barrier. Furthermore, a pet owner may encounter other boundary issues with their pet that a barrier or other deterrent would prove ineffective against. Such problems may include, but not be limited to, a pet urinating in a particular spot, defacing the back of a couch, or destroying a potted plant.

A variety of pet deterrents have been developed to establish off-limits areas in a home or to confine pets to specific locations such as a living room. U.S. Patent Application Publication No. US 2005/0263100 A1 filed by Joseph Kover Jr., Scott L. Maxfield, and Robert N. Silvester (hereinafter “Kover”) submits a collarless containment system for a pet. U.S. Pat. No. 5,603,287 issued to George B. Houck (hereinafter “Houck”) submits an animal sensing and repelling system. U.S. Patent Application Publication No. US 2012/0137987 filed by Clermont Ferrand Jean Moulin (hereinafter “Moulin”) submits a method and a device for making an area off-limits to a pet. U.S. Pat. No. 4,967,695 issued to James M. Giunta (hereinafter “Giunta”) submits a system for controlling the movement of an animal. U.S. Pat. No. 6,158,392 issued to Max Andre and Xavier Aubrey (hereinafter “Andre”) submits a device for prohibiting the crossing of a zone boundary by an animal. U.S. Pat. No. 5,893,446 issued to Lee A. Reich (hereinafter “Reich”) submits a wild animal deterrent device. U.S. Pat. No. 6,016,100 filed by Randal D. Boyd and Walter J. Frankewich, Jr. (hereinafter “Boyd”) submits an ultrasonic animal deterrent for protecting an area. U.S. Pat. No. 6,615,170 issued to Jesse F. Patterson, Tristan M. Christianson, Edward C. McKinney, Jr., and Andrew J. Parker (hereinafter “Patterson”) submits a method and apparatus to control animal behavior. U.S. Pat. No. 3,980,051 issued to Charles M. Fury (hereinafter “Fury”) submits a range triggered animal training system. Lastly, U.S. Pat. No. 6,431,122 filed by Michael D. Westrick, Scott E. Maddox, Peter F. Johnson, and Timothy J. Hacha (hereinafter “Westrick”) submits a wireless confinement and training system for an animal.

Each aforementioned system has shortcomings. First, Kover's collarless containment system for a pet lacks a mechanism for discerning a human being from a pet and/or animal; therefore, when a human being passes beyond an established boundary in Kover's system, the human is subjected to a liquid stimulus just as the pet and/or animal would be when crossing the established boundary. This may prove to become a nuisance to pet owners who would feel like prisoners in their own home. Additionally, Kover's system may result in an unnecessary amount of fluids dispensed which may damage walls, certain types of flooring, or furniture.

Second, the systems of Kover, Houck, Moulin, Giunta, Andre, and Reich all function by using a transmitter and/or a receiver affixed to a pet's collar. Such devices deliver a stimulus such as an electric shock to the pet when entering a protected area. This scheme for deterring a pet from a protected area may be viewed as cruel or inhumane to pets by many organizations. Additionally, each pet is required to wear its own collar which may prove to be expensive for the pet owner for at least two reasons: the cost of each additional collar, and the cost for continually needing to replace batteries on such collars. Finally, collared deterrent systems may be cumbersome when used on small pets such as felines or small dogs.

Lastly, the remaining systems of Boyd, Patterson, Fury, and Westrick all employ either motion, infrared, vibration, sound, or heat activated pet deterrent devices, or a combination of such devices. These devices are typically built to operate in an outdoor environment and are unable to discern a pet from a human; thus, a human may be sanctioned when entering the protected area. Additionally, these devices are not customizable. For example, current motion activated pet deterrent spray systems are triggered either by motion occurring within a certain radius of the deterrent system or by means of a pet traveling close to an infrared sensor. These devices lack range-triggering selectivity because users cannot program or set accurate custom distances which activate or deactivate pet stimuli systems.

Accordingly, there is a need for a human-sensing indoor pet deterrent system which deters a pet from entering a protected area. Such a pet deterrent system uses a mechanism that can discriminate between a human being and a pet so that the human is not subjected to the system's pet stimulus when entering the protected area. Hence, there is a need for a pet deterrent system that is selective in what distance ranges trigger the fluid spray system. Further, there is a need for a pet deterrent system which detects the presence of a pet in a specific area and deliver spray or mist stimulus until the pet leaves the specified preset range. Finally, there is a need for a pet deterrent system that functions in a wide variety of locations that a pet owner may want to keep a pet away from.

Therefore, it is an object of the present invention to provide a pet deterrent system which is able to discern between a human being and a pet.

Another object of the present invention is to deter a pet from a protected area by means of a fluid spray stimulus system only if a pet is detected in the protected area and to deactivate the fluid sprayer for a preset duration if a human is detected in the protected area.

It is also an object of the present invention to provide a pet deterrent system that either visually or audibly informs a human when the human is detected by the system. This visual or audible cue will signify to the human that the system is deactivated and that it is safe to pass into the protected area.

It is a further object of the present invention to provide a pet deterrent system that exploits the accurate distance measuring capabilities of ultrasonic beam sensors. This allows pet owners to program custom preset distances for triggering the fluid spray system when a pet is detected as well as custom preset distances for deactivating the fluid spray system when a human is detected.

Yet another object of the present invention is to provide a pet deterrent system that is versatile and may be mounted to function as either a stand-alone pet deterrent device for protecting an area or in conjunction with a pet barrier to deter a pet from overcoming the barrier and entering a protected area. Accordingly, the ultrasonic distance sensor designated for detecting the pet may be mounted at various heights to accommodate for varying pet heights, and the ultrasonic distance sensor designated for detecting the human can also be mounted at various heights and angles to accommodate for varying human heights.

### BRIEF SUMMARY OF THE INVENTION

Disclosed is a human sensing pet deterrent system capable of protecting a specific indoor area (the protected area). The pet deterrent system includes a microcontroller which controls a human detection system, a pet detection system, and a fluid spray stimulus system. Both the human detection and pet detection systems include ultrasonic beam sensors for determining when a pet enters the protected area and for determining when a human is approaching or is in the protected area. The fluid spray stimulus system is activated when a pet enters the protected area and is deactivated for a preset duration as a human approaches or passes into the protected area. The fluid spray stimulus system delivers a non-harmful fluid stimulus such as water to the protected area to discourage a pet from entering the protected area and continues to deliver the stimulus until the pet leaves the protected area.

The human detection system employs at least one ultrasonic distance sensor. The said ultrasonic distance sensor or sensors are mounted in the protected area at a height greater than a pet's stature and at a height less than a typical human's stature and produce at least one ultrasonic sound beam parallel to the ground and pointed in the direction by which a human may wish to enter the protected area. The ultrasonic distance sensor or sensors are also positioned such that a human may not approach the protected area without traversing the ultrasonic sound beam or beams and thus be detected. Each ultrasonic distance sensor in the human detection system is capable of measuring the distance between the ultrasonic distance sensor or sensors and the human. This distance measuring is accomplished using the concept of sonar in which an ultrasonic pulse is transmitted from the sensor or sensors to the human, and distance-to-target is determined by monitoring the time required for the echo return from the human to the sensor or sensors.

The pet detection system functions in a similar manner to the human detection system. The pet detection system also employs at least one ultrasonic beam sensor or sensors. The ultrasonic distance sensor or sensors are mounted in the protected area at a height equal to the pet's stature, are parallel to the ground, and are positioned such that a pet may not enter a protected area without traversing the ultrasonic beam produced by the ultrasonic distance sensor or sensors.

The fluid spray stimulus system comprises a motorized sprayer coupled to a reservoir which is capable of holding a non-harmful and non-toxic fluid such as water. The fluid spray stimulus system is placed in or near the protected area and is positioned such that when the fluid spray stimulus system is activated, it delivers a spray that envelops at least a portion of the protected area and influences a pet to leave the protected area.

Preferably, the fluid spray stimulus system, the human detection system, and the pet detection system are wired electronically to a relay controlled by the microcontroller. When the human sensing pet deterrent system is turned on, the microcontroller uses software that activates the ultrasonic distance sensors in both the human detection system and the pet detection system. The microcontroller then collects distance information from each sensor. First, an algorithm in the microcontroller checks to see if a distance received by any of the sensor or sensors in the human detection system is less than a distance preset by the user. If so, then the microcontroller disables the fluid spray stimulus system for a first preset duration. If the distance received by any of the sensor or sensors in the human detection system is greater than the distance preset by the user, the fluid spray stimulus system is not disabled. Next, the microcontroller checks to see if the distance received by any of the sensors in the pet detection system is less than the distance preset by the user. If this is the case, the fluid spray stimulus system is activated for a second preset duration. After the fluid spray stimulus system delivers a spray for the second preset duration, the pet detection system continues to check to see if the pet is still in the protected area or if the pet has left the protected area. If the pet detection system has determined that the pet is still in the protected area, the fluid spray system is activated again for the second preset duration. If the pet has left the protected area, the human and pet detection systems return to a monitoring mode for the protected area.

### BRIEF DESCRIPTION OF THE DRAWINGS

FIG. 1 is a flow diagram which represents the logical flow of the algorithm embodied in the human detecting pet deterrent system.

FIG. 2 illustrates the human sensing pet deterrent system setup in a preferred embodiment of the present invention. In this setup, the human sensing pet deterrent system is configured to deter a pet from overcoming the existing pet barrier which is located in a doorway. In this preferred embodiment, there are two human-sensing sensors and one pet-sensing sensor.

FIG. 3 discloses the multiple components that comprise embodiments of a human sensing pet deterrent system.

FIG. 4 depicts a top view of the sensor configuration illustrated in FIG. 2.

FIG. 5 depicts a top view of an alternate placement of the sensors embodied in the human detecting pet deterrent system.

### DETAILED DESCRIPTION OF THE INVENTION

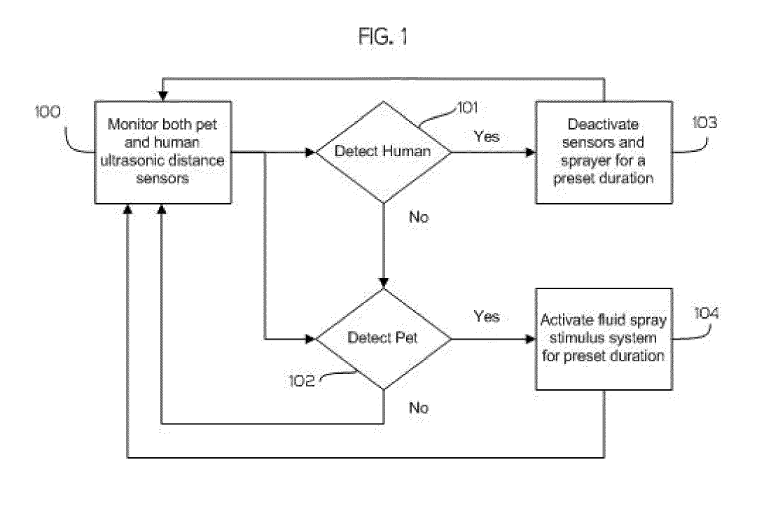

The illustrations and diagrams in FIGS. 1, 2, 3, 4, and 5 for embodiments of a human sensing pet deterrent system for protecting an indoor area will now be addressed in full detail.

FIG. 1 is a flow diagram which represents the logical flow of the algorithm embodied in the human detecting pet deterrent system for protecting an indoor area. When the human detecting pet deterrent system is powered on, a control source comprising a microcontroller and supporting circuitry monitors both the human and pet sensors. This process begins with box 100. If the human detecting ultrasonic distance sensor or sensors detect the presence of a human 101 based on the human's height, the human detecting pet deterrent system is deactivated 103 by the control source by means of an internal clock for a first preset duration before returning to a monitoring mode 100 for the human and pet detecting sensors. This means that a spray stimulus cannot be delivered during the preset duration time period. If the distance received by any sensor or sensors in the human detection system is greater than the distance preset by the user, the fluid spray stimulus system is not disabled. If the pet detecting ultrasonic distance sensor or sensors detect the presence of a pet 102 based on the pet's height, the fluid sprayer system is activated 104 for a second preset duration. After the fluid spray stimulus system delivers a spray for the second preset duration, the pet detection system continues to monitor 100 and checks to see if the pet is still in the protected area or if the pet has left the protected area. If the pet detection system has determined that the pet is still in the protected area, the fluid spray system is activated again 104 for the second preset duration. If the pet has left the protected area, the control source then resumes monitoring and controlling 100 the human detecting pet deterrent system.

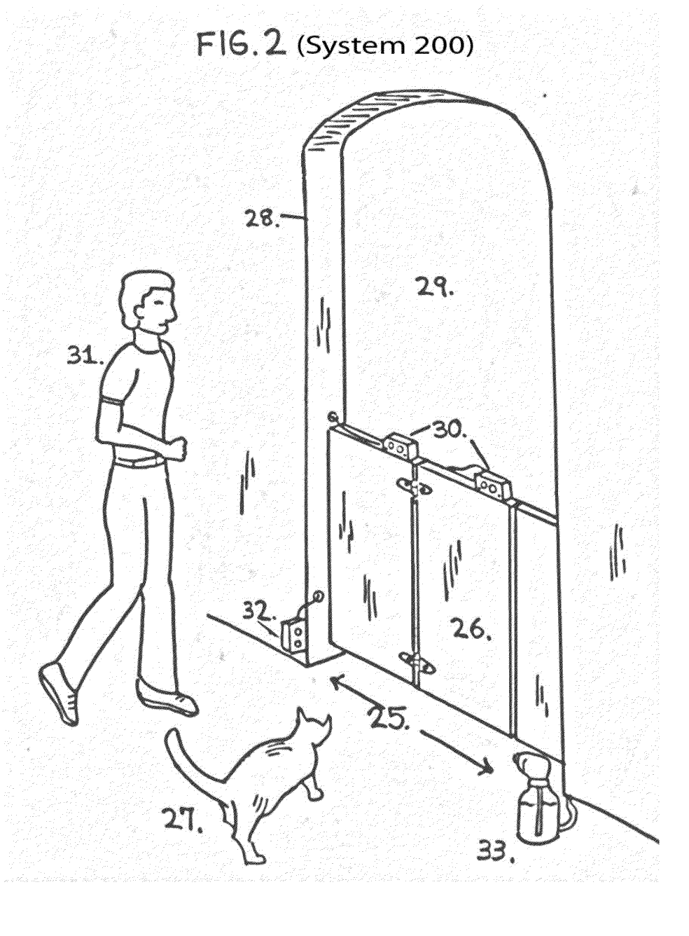

FIG. 2 illustrates a preferred embodiment of the human sensing pet deterrent system 200 for protecting an indoor area. System 200 includes human detection sensors 30, a pet detection sensor 32, and a fluid spray stimulus system 33. In the preferred embodiment, two human detection sensors and one pet detection sensor are illustrated; however, the present invention is not limited thereto. One of ordinary skill in the art will appreciate that any number of sensors may be used for each of the human detection sensor(s) 30 and the pet detection sensor(s) 32.

FIG. 2 further illustrates a typical placement for the sensors in the human sensing pet deterrent system in conjunction with a pet barrier 26. In a preferred embodiment, the pet barrier 26 may be a hinged gate affixed to a doorway 28; however, the present invention is not limited thereto, and any type of pet barrier known in the art may be used. The sensors 30 in the human detection system are positioned in the protected area at a height greater than a height of a pet 27 and less than a typical height of a human 31, and the sensors 30 produce ultrasonic sound beams parallel to the ground and pointed in the direction from which a human 31 may wish to enter a protected area 29. In this illustration, the human 31 is approaching the protected area 29 which is the room beyond the doorway 28. However, the protected area 29 is not limited to a room beyond a doorway and may be any area by which a pet may be prevented from entering. The protected area 29 may also be a protected area located outdoors (such as, for example, a fenced garden or a shed) instead of indoors. (doesn't this conflict with the title of the invention? . . . “protecting and INDOOR area”? The protected area 29 may also be surrounding an object that one wishes to protect from pet interaction. One of ordinary skill in the art will appreciate that the protected area is any area capable of being protected by the human sensing pet deterrent system within reasonable scope of the present invention.

When the human 31 traverses within a preset distance set within the human detection sensors 30, the entire human sensing pet deterrent system is deactivated for a first preset duration, enabling the human to pass through the existing pet barrier 26 into the protected area 29 without activating the fluid spray stimulus system 33. The pet detection sensor 32 is mounted at the height of the pet 27 such that if the pet were to traverse upon the protected area by crossing into a pet detection zone 250, the fluid spray stimulus system 33 activates and discourages the pet 27 away from the protected area. The fluid spray stimulus system 33 is placed near the protected area 29 and, if activated, delivers a spray within the pet detection zone 250 in order to discourage the pet 27 from overcoming the pet barrier 26 and entering the protected area 29. The control and monitoring source for the human sensing pet deterrent system is not shown in FIG. 2.

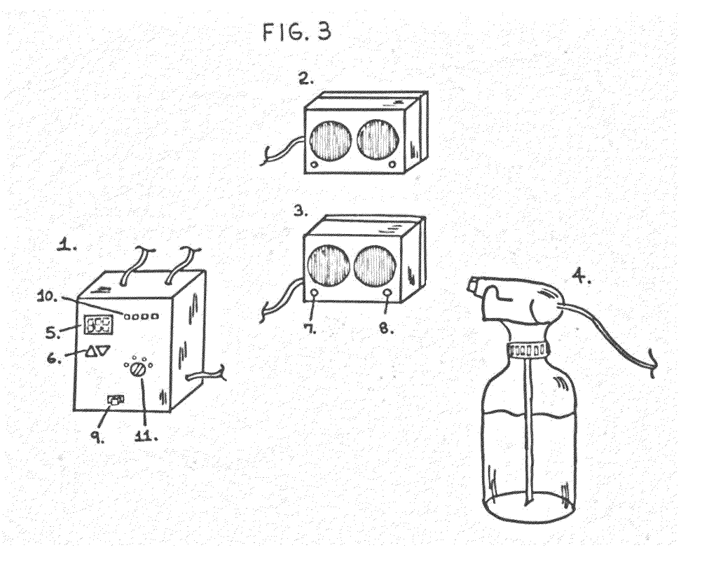

FIG. 3 discloses the multiple components that comprise embodiments of a human sensing pet deterrent system. The multiple components include the control source box 1, at least one human detecting ultrasonic distance sensor 2, at least one pet detecting ultrasonic distance sensor 3, and a motorized fluid spray system 4. In a preferred embodiment, each of the aforementioned components 2, 3, and 4 are connected to the control source box 1 by means of electrical wires. However, the present invention is not limited thereto, and a wireless communications system including components 1, 2, 3, and 4 is possible. For example, components 2, 3, and 4 may remotely communicate with control source box 1, a computer system (not shown), or both. One of ordinary skill in the art will appreciate that any coupling of components 1, 2, 3, and 4 may be achieved within reasonable scope of the present invention.

The control source box 1 is powered by a power supply (not shown), a battery (not shown), or a combination of both. The control source box 1 is comprised of a power switch 9 to turn the system on and off, a display such as a Light-Emitting Diode (LED) display 5 capable of displaying numbers, and a microcontroller (not shown) enclosed within the box. The display 5 is used in conjunction with programming buttons 6 which are up and down arrow buttons labeled “Increase” and “Decrease” to program the preset distances for each of the ultrasonic distance sensors. For example, if a user of the human sensing pet deterrent system requires a distance of 100 centimeters to be assigned to the human detecting ultrasonic sensor 2, the programming buttons 6 would be used to increase or decrease this distance until it reaches 100 centimeters. This indicates that when a human approaches the human sensing pet deterrent system and comes within 100 centimeters of it, the system would then deactivate for a preset duration. The preset duration may be programmed by a user to be in seconds, minutes, or even hours. Of course, any time duration may be preset within reasonable scope of the present invention. LED indicator light 7 on the human detecting ultrasonic sensor 2 would glow green if the human is detected signaling the human can traverse into the protected area without activating the fluid spray stimulus system. LED indicator light 8 would glow red if the human is not detected, signaling that the system is armed and ready to sanction a pet that traverses into the protected area. Of course, embodiments of the present invention are not only limited to LED lights for signaling whether or not the system is armed. One of ordinary skill in the art will appreciate that any signaling method may be used, for example, an alarm sound. The pet detecting ultrasonic distance sensor 3 is programmed in the same manner as the human detecting ultrasonic distance sensor 2. A sensor selection switch 11 is used to select the ultrasonic distance sensor that a user wishes to program. Indicator lights 10 allow the user to visually observe which ultrasonic distance sensor is selected for distance programming.

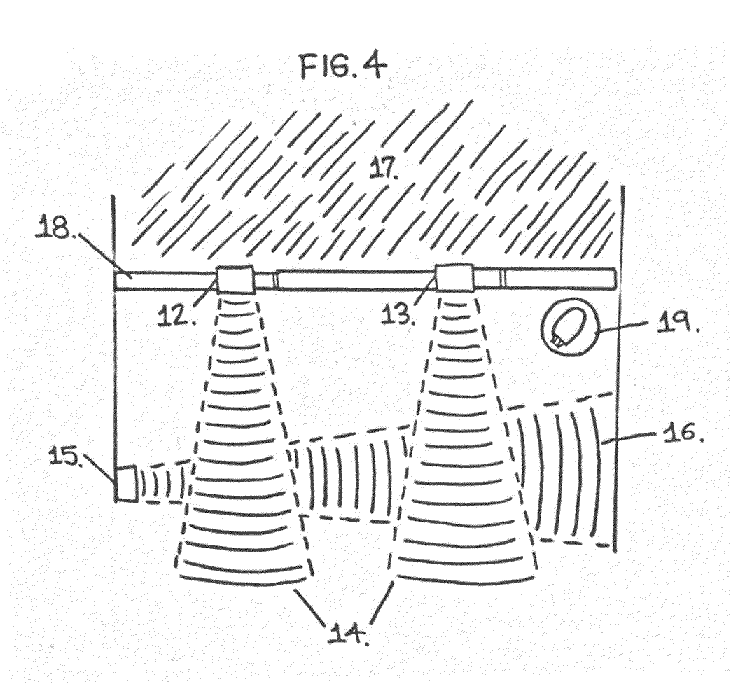

FIG. 4 depicts a top view of the sensor configuration illustrated in FIG. 2. The human detecting sensors 12, 13 are mounted on an existing pet barrier 18 and produce, in this example, two sonar zones 3 for human detection. The pet detecting sensor 15 produces a pet detecting sonar zone 16 for pet detection. The fluid spray system 19 is located near the protected area 17. Of course, embodiments of the present invention are not limited to only two sonar zones for human detection and one sonar zone for pet detection. One of ordinary skill in the art will appreciate that any number of sonar zones may be used for each of human and pet detection.

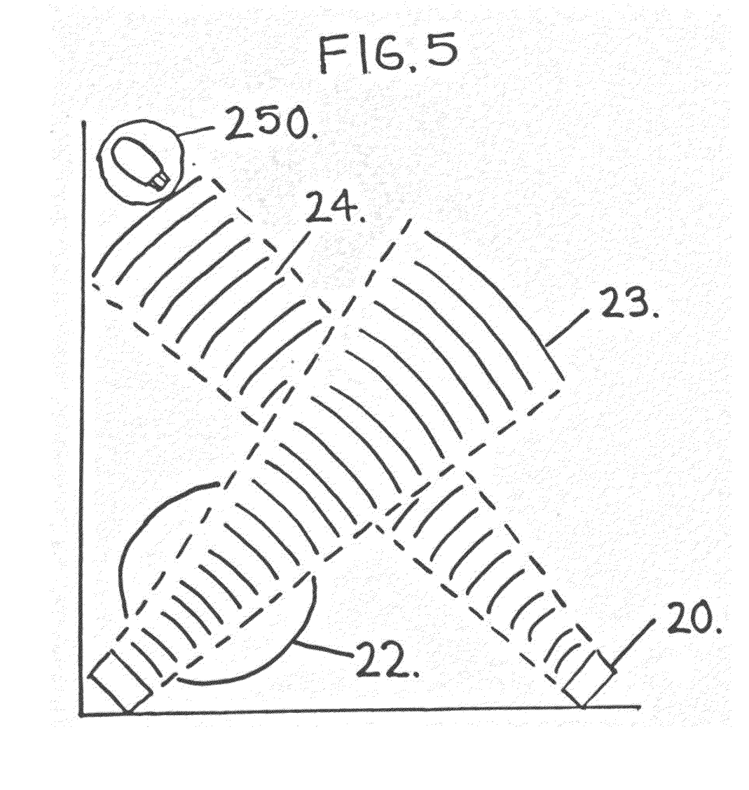

FIG. 5 depicts a top view of an alternate placement of the sensors embodied in the human detecting pet deterrent system for protecting an indoor area. In this illustration, the protected area 5 may be a household item such as a potted plant which is off-limits to a pet. The pet detection sensor 20 is placed at the pet's height and produces a sonar zone 24 for pet detection. If a pet traverses into this sonar zone 24, the fluid spray stimulus system 25 is activated and encourages the pet to leave the protected area. The human detection sensor 21 is mounted at a height greater than the pet detection sensor 20 and produces a sonar zone 23 for human detection. If a human was to approach the protected area to, for example, water a potted plant 22, the human would be detected by the human detection sensor 21 in zone 23, thus deactivating the human detecting pet deterrent system for a preset duration and allowing the human to water the potted plant 22 without activating the fluid spray stimulus system 25.

While described embodiments of the present invention have referred to a human and a pet, the present invention is not limited thereto, and any type of moving entity may be used. For example, if a protected area is outdoors, a wild animal such as a raccoon may be substituted for a domesticated pet. The preferred embodiment of the invention has the protected area as an indoor area, however the human sensing pet deterrent system may also be used outdoors. Additionally, a robot may be allowed to enter a protected area instead of, or along with, a human if the robot's height is set accordingly to allow entry into the protected area. One of ordinary skill in the art will appreciate that any moving entities with heights that are different from one another are capable of interacting with the human sensing pet deterrent system within reasonable scope of the present invention.

While the invention has been described in conjunction with specific embodiments thereof, it is evident that many alternatives, modifications, and variations will be apparent to those skilled in the art in light of the foregoing disclosure. Accordingly, it is intended to embrace all such alternatives, modifications, and variations that fall within the spirit and scope of the appended claims.

What is claimed is:

1. A system for protecting an area, the system comprising:
a first hardware sensor system including at least one sensor that detects if a first moving entity enters a first zone;
a second hardware sensor system including at least one sensor that detects if a second moving entity enters a second zone that is different from the first zone;
a stimulus system; and
a control system that:
monitors the first hardware sensor system and the second hardware system;
deactivates the stimulus system if the first moving entity is detected within the first zone; and
activates the stimulus system if the second moving entity is detected within the second zone.

2. The system of claim 1, wherein the first moving entity is at a first height, and the second moving entity is at a second height that is different from the first height.

3. The system of claim 2, wherein the first zone is associated with the first height, and the second zone is associated with the second height.

4. The system of claim 2, wherein the first hardware sensor system is physically mounted at the first height, and the second hardware sensor system is physically mounted at the second height.

5. The system of claim 1, further comprising an alarm system that includes at least one of a displayed alarm or an alarm sound, the alarm system configured to activate when the first moving entity is detected within the first zone.

6. The system of claim 1, wherein the stimulus system is a fluid spray stimulus.

7. The system of claim 1, wherein the control system is further configured to deactivate the stimulus system for a first time period if the first moving entity is detected within the first zone, and the control system is further configured to activate the stimulus system for a second time period if the second moving entity is detected within the second zone.

8. The system of claim 7, wherein the first time period and the second time period are preset by a user.

9. The system of claim 1, wherein the first hardware sensor system includes one or more ultrasonic beams positioned parallel to a ground surface.

10. A hardware-implemented method for protecting an area, the method comprising:
detecting if a first moving entity enters a first zone;
detecting if a second moving entity enters a second zone;
deactivating a stimulus system if the first moving entity is detected within the first zone; and
activating the stimulus system if the second moving entity is detected within the second zone.

11. The method of claim 10, wherein the first zone is different from the second zone.

12. The method of claim 10, wherein the first moving entity is at a first height, and the second moving entity is at a second height that is different from the first height.

13. The method of claim 11, wherein the first zone is associated with the first height, and the second zone is associated with the second height.

14. The method of claim 11, further comprising:
physically mounting a first hardware sensor system including at least one sensor at the first height; and
physically mounting a second hardware sensor system including at least one sensor at the second height.

15. The method of claim 14, wherein the first hardware sensor system includes one or more ultrasonic beams positioned parallel to a ground surface.

16. The method of claim 10, further comprising activating an alarm system that includes at least one of a displayed alarm or an alarm sound, the alarm system configured to activate when the first moving entity is detected within the first zone.

17. The method of claim 10, wherein the stimulus system is a fluid spray stimulus.

18. The method of claim 10, wherein the deactivating further comprises deactivating the stimulus system for a first time period if the first moving entity is detected within the first zone, and the activating further comprises activating the stimulus system for a second time period if the second moving entity is detected within the second zone.

19. The method of claim 18, wherein the first time period and the second time period are preset by a user.

20. A system, comprising:
means for detecting if a first moving entity enters a first zone;
means for detecting if a second moving entity enters a second zone that is different from the first zone;
means for providing a stimulus;
means for deactivating the stimulus if the first moving entity is detected within the first zone; and
means for activating the stimulus if the second moving entity is detected within the second zone.
